(19) United States
(12) Patent Application Publication
(10) Pub. No.: US 2009/0023479 A1
(43) Pub. Date: Jan. 22, 2009

(54) METHOD AND SYSTEM FOR ROUTING PHONE CALL AUDIO THROUGH HANDSET OR HEADSET

(75) Inventor: Robert W. Hulvey, Redondo Beach, CA (US)

Correspondence Address: FIALA & WEAVER, P.L.L.C.;C/O INTELLEVATE, P.O. BOX 52050, MINNEAPOLLS, MN, 55402, US

(73) Assignee: BROADCOM CORPORATION, Irvine, CA (US)

(21) Appl. No.: 11/960,191

(22) Filed: Dec. 19, 2007

Related U.S. Application Data
(60) Provisional application No. 60/950,251, filed on Jul. 17, 2007.

(51) Int. Cl. H04M 1/05

(52) U.S. Cl. 455/569.1

(57) ABSTRACT

Methods, systems, and apparatuses for routing received telephone call audio through a mobile phone handset or associated wireless headset are described. The handset is configured to wirelessly communicate with a headset. An audio signal is received that is generated by a microphone of the handset or headset. The audio signal is compared to a reference signal to generate an audio source determination. In a first aspect, the comparison is performed in the handset. In an alternative aspect, the comparison is performed in the headset. One of the handset or headset is selected to provide further audio information associated with a received telephone call based on the audio source determination.

This application claims the benefit of U.S. Provisional Appl. No. 60/950,251, filed Jul. 17, 2007, which is herein incorporated by reference in its entirety

### BACKGROUND OF THE INVENTION

1. Field of the Invention

The present invention relates to mobile phones that communicate with wireless headsets, and more particularly to telephone call routing with regard to mobile phones and wireless headsets.

2. Background Art

Wireless headsets are being increasingly used by persons in combination with mobile phones. For example, BLUETOOTH wireless headsets are in wide use today with BLUETOOTH-enabled mobile phones. A variety of styles of wireless headsets exist. Frequently, a wireless headset is secured over an ear of a user, to position a speaker of the headset adjacent to the user's ear. A boom that contains a microphone may extend from the headset toward the mouth of the user to capture voice information from the user.

A common problem exists for users in answering telephone calls with the mobile phone-wireless headset combination. When a mobile phone user picks up the mobile phone to answer a telephone call, the mobile phone will typically page the headset and connect to the headset, and audio related to the telephone call is automatically routed to the headset. If the user cannot immediately locate the headset and/or cannot immediately install the headset on his/her ear, the user is often unable to hear or speak with the remote party. This is a serious nuisance to the user.

Thus, what is desired is an improved way for users to answer telephone calls received on a mobile phone that operates with a headset.

### BRIEF SUMMARY OF THE INVENTION

Methods, systems, and apparatuses for routing received telephone call audio received by a mobile phone handset-wireless headset combination are described. The handset is configured to wirelessly communicate with the headset. An audio signal associated with a received telephone call is generated. The audio signal is compared to a reference signal to generate an audio source determination. In a first aspect, the comparison is performed in the handset. In an alternative aspect, the comparison is performed in the headset. One of the handset or headset is selected to receive routing of subsequent audio information associated with the received telephone call based on the audio source determination.

In one example, the audio signal is generated by a microphone in the mobile phone handset from voice information received by the microphone at the handset. In such an example, the reference signal may be a predetermined threshold value or may be a second audio signal generated by a microphone in the headset from voice information.

In another example, the audio signal is generated by the microphone in the headset from voice information received by the microphone in the headset. In such an example, the reference signal may be a predetermined threshold value or may be a second audio signal generated by the microphone in the mobile phone handset from voice information.

In an example further aspect, one of the microphone of the handset and the microphone of the headset that was not selected to provide further audio associated with the received telephone call may optionally be disabled.

An attribute of the audio signal may be compared to the reference signal to generate the audio source determination, such as an amplitude, sound energy at specific frequencies, average power, or other relevant attribute of the audio signal.

In another aspect of the present invention, a mobile phone handset is provided. The mobile phone handset includes a microphone, a communication interface configured to wirelessly communicate with a headset, and compare logic. The compare logic is configured to compare an audio signal generated by the microphone (or a microphone of the headset) to a reference signal to generate an audio source determination. One of the handset microphone and a second microphone located in the headset is selected to provide further received audio information associated with a received telephone call based on the audio source determination.

In still another aspect of the present invention, a wireless headset is provided. The wireless headset includes a microphone, a communication interface configured to wirelessly communicate with a mobile phone handset, and compare logic. The compare logic is configured to compare an audio signal generated by the microphone (or a microphone of the handset) to a reference signal to generate an audio source determination. One of the headset microphone and a second microphone located in the mobile phone handset is selected to provide further received audio information associated with a received telephone call based on the audio source determination.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a diagram illustrating an example conventional mobile phone and wireless headset system.

FIG. 2 shows a flowchart providing example steps in a mobile phone handset for routing audio related to a telephone call, according to example embodiments of the present invention.

FIGS. 3-5 show system block diagrams for determining telephone call audio routing, according to example embodiments of the present invention.

FIG. 6 shows a flowchart providing example steps in a wireless headset for routing audio related to a telephone call, according to example embodiments of the present invention.

FIGS. 7 and 8 show system block diagrams for determining telephone call audio, routing, according to example embodiments of the present invention.

FIG. 9 shows a block diagram of an example cell phone in which an embodiment of the present invention may be implemented.

FIGS. 10 and 11 show audio signal compare logic implemented in cell phone digital and analog baseband sections, according to example embodiments of the present invention.

FIG. 12 shows a block diagram of an example BLUETOOTH headset in which an embodiment of the present invention may be implemented.

FIG. 13 shows audio signal compare logic implemented in a BLUETOOTH headset processor, according to an example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### Conventional Mobile Phone—Wireless Headset System

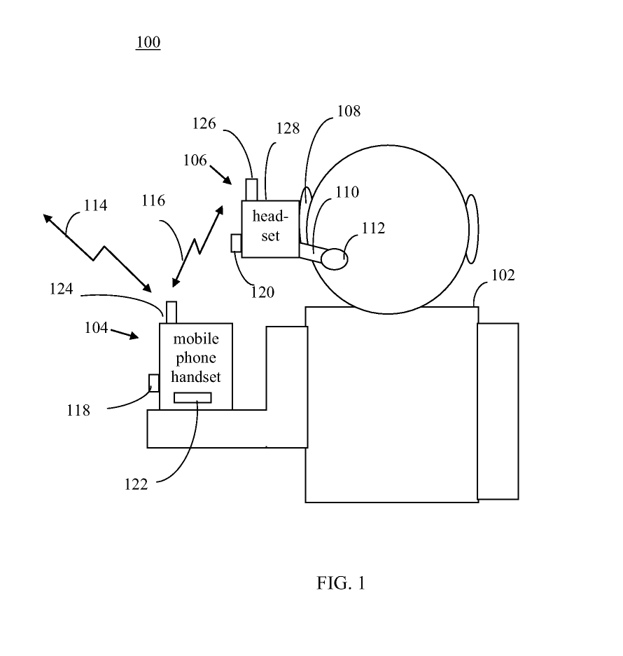

As described above, mobile phones are being more frequently used with wireless headsets. FIG. 1 shows a diagram illustrating an example conventional mobile phone and wireless headset communication system 100. As shown in the example of FIG. 1, a user 102 carries a mobile phone handset 104 and wears a wireless headset 106. Not all features of mobile phone handset 104 and wireless headset 106 are necessarily shown in FIG. 1, for reasons of brevity. As shown in FIG. 1, mobile phone handset 104 includes an answer button 118, a microphone 122, and an antenna 124. Wireless headset 106 includes a body 128, a boom 110, a microphone 112, an answer button 120, and an antenna 126.

Wireless headset 106 is attached to an ear 108 of user 102, to position a speaker of wireless headset 106 adjacent to his/her ear 108. For example, wireless headset 106 may include an ear hook (not shown) that hooks over ear 108 to secure wireless headset 106 to user 102. Alternatively, wireless headset 106 may be an “in ear” style (e.g., an “ear bud” or “canalphone”) that plugs directly into an ear canal of ear 108. Boom 110 may extend from body 128 of headset 106 toward the mouth of user 102 to capture voice information from user 102 at microphone 112. Alternatively, microphone 112 may be located in a portion of body 128 adjacent to ear 108, and boom 110 may not be present.

As shown in FIG. 1, mobile phone handset 104 receives a telephone call 114 at antenna 124. User 102 picks up mobile phone handset 104 to answer telephone call 114. For example, user 102 may press answer button 118, or may answer the telephone call 114 on handset 104 in other ways (e.g., flipping open handset 104, etc.). Typically, mobile phone handset 104 pages wireless headset 106 using a wireless communication link 116 to connect to wireless headset 106, and automatically routes audio related to telephone call 114 to wireless headset 106 over wireless communication link 116. Wireless communication link 116 is established between antenna 124 of handset 104 and antenna 126 of headset 106. For example, wireless communication link 116 may be established according to the BLUETOOTH communication protocol, or other wireless communication protocol. Note that in an embodiment, mobile phone handset 104 may have multiple antennas, using separate antennas for telephone call 114 and wireless communication link 116.

User 102 is not necessarily always wearing wireless headset 106 as shown in FIG. 1. For example, when not using wireless headset 106, user 102 may remove wireless headset 106 from ear 108 and place wireless headset 106 in a pocket, on a desk, dresser or other surface, in a purse, etc. Thus, when mobile phone handset 104 receives telephone call 114, and automatically routes call audio to wireless headset 106, if user 102 cannot immediately locate or install wireless headset 106 on ear 108, user 102 is unable to hear or speak with the remote party initiating telephone call 114. This can be a serious nuisance to user 102, where voice information related to telephone call 114 may not be received by user 102, the remote party may hang up, etc.

The following section describes example embodiments of the present invention which overcome these deficiencies of conventional mobile phone-wireless headset combinations.

### EXAMPLE EMBODIMENTS

The example embodiments described herein are provided for illustrative purposes, and are not limiting. The examples described herein may be adapted to any type of mobile phone and wireless headset. Further structural and operational embodiments, including modifications/alterations, will become apparent to persons skilled in the relevant art(s) from the teachings herein.

Typically, a user answers a telephone call either by answering the call at the mobile phone handset or at the wireless headset. For example, in FIG. 1, user 102 may push answer button 118 on mobile phone handset 104 or answer button 120 on wireless headset 106 to initiate answering the telephone call. When user 102 initiates answering telephone call 114 by interacting with wireless headset 106, it is highly likely that user 102 wishes to route the audio related to telephone call 114 through wireless headset 106. In the case where user 102 initiates answering telephone call 114 by interacting with mobile phone handset 104, it is not always clear whether user 102 will be speaking into handset 104 or into headset 106. Thus, in this case, when audio is automatically routed through headset 106 in a conventional manner, this may cause problems for user 102 in answering telephone call 114.

According to embodiments of the present invention, to determine whether to route audio related to the telephone call to the mobile phone handset or to the mobile phone headset, a measure of the audio signal energy (or other signal attribute) is taken from a microphone of the handset, a microphone of the headset, and/or from both microphones. The measured audio signal energy is used to determine whether to route the audio related to the telephone call through the mobile phone handset or the wireless headset. Embodiments are described below for mobile phone handsets and wireless headsets that are configured for call routing.

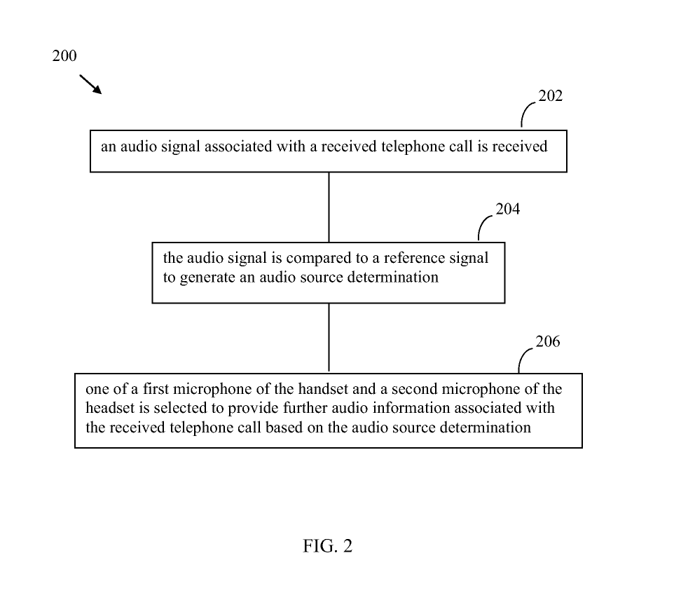

For example, FIG. 2 shows a flowchart 200 providing example steps in a mobile phone handset for routing audio related to a telephone call, according to example embodiments of the present invention. Other structural and operational embodiments will be apparent to persons skilled in the relevant art(s) based on the following discussion.

Flowchart 200 begins with step 202. In step 202, an audio signal associated with a received telephone call is received. For example, in FIG. 1, after user 102 initiates answering telephone call 114 on mobile phone handset 104 (e.g., by pressing answer button 118), user 102 typically voices a greeting, such as “Hello” into microphone 122 of mobile phone handset 104 or microphone 112 of wireless headset 106. User 102 typically directs his/her voice into the one of mobile phone handset 104 or wireless headset 106 that user 102 intends to use for conducting telephone call 114, although the voice may be heard more faintly by the other of mobile phone handset 104 or wireless headset 106 (if on). Thus, the voice information may be received by one or both microphones, and is converted into an electrical audio signal by microphone 122 of mobile phone handset 104 and/or by microphone 112 of wireless headset 106.

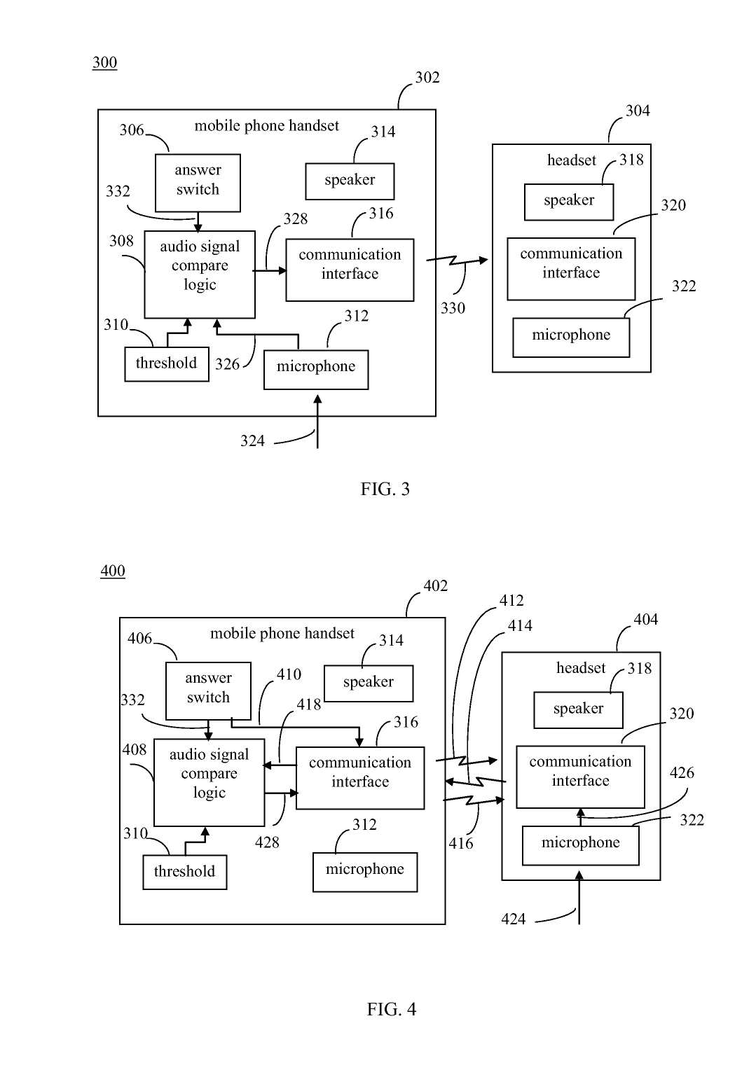

In step 204, the audio signal is compared to a reference signal to generate an audio source determination. In an embodiment of flowchart 200, the audio signal is compared to a reference signal in the mobile phone handset to determine into which of the handset or headset the voice information was directed by the user. For instance, in an embodiment, the reference signal is a predetermined threshold value, and the audio signal may be generated from voice information received at the handset or headset. In another embodiment, the reference signal may be a second audio signal. For example, the first audio signal may be generated from voice information received at the mobile phone handset, and the second audio signal may be generated from the voice information received at the wireless headset. In any event, the compare of the audio signal to the reference signal is performed in the mobile phone handset to generate a determination of whether the user is directing voice information into the microphone of the handset or a microphone of the headset. Example embodiments for performing step 204 using compare logic are described in further detail below with regard to FIGS. 3-5.

In step 206, one of a first microphone of the handset and a second microphone of the headset is selected to provide further audio information associated with the received telephone call based on the audio source determination. Likewise, one of a first speaker of the handset and a second speaker of the headset may be selected for outputting sound audio. If it is determined from step 204 that the voice information was directed by the user into the mobile phone handset, audio related to the telephone call is routed through the mobile phone handset. Conversely, if it is determined from step 204 that the voice information was directed by the user into the wireless headset, audio related to the telephone call is routed through the wireless headset.

In an embodiment, once it is determined which of the mobile phone handset or wireless headset is to be used to route audio related to the telephone call, audio may be optionally disabled in the other of the mobile phone handset or wireless headset for the remainder of the telephone call.

In an embodiment, before determination is made to which of the mobile phone handset or wireless headset the audio should be routed, audio related to the telephone call may be routed to both the first speaker of the handset and the speaker of the headset for a brief period. This enables the user to receive the audio information regardless of which speaker the user has placed to his or her ear.

Embodiments for performing flowchart 200 may be implemented in a mobile phone handset in a variety of ways. For example, FIGS. 3-5 show block diagrams of systems for determining the routing of telephone call, according to example embodiments of the present invention.

For instance, FIG. 3 shows a block diagram of a telephone call routing system 300, according to an example embodiment of the present invention. As shown in FIG. 3, system 300 includes a mobile phone handset 302 and a headset 304. Mobile phone handset 302 includes an answer switch 306, audio signal compare logic 308, a threshold 310, a first microphone 312, a first speaker 314, and a first communication interface 316. Headset 304 includes a second speaker 318, a second communication interface 320, and a second microphone 322.

Answer switch 306 of mobile phone handset 302 is any type of mechanism that enables a user (e.g., user 102 shown in FIG. 1) to answer a telephone call (e.g., telephone call 114) using mobile phone handset 302. Thus, for example, answer switch 306 may be included in an answer button (e.g., answer button 118), a voice activated call-answering mechanism, a switch that is activated when a user flips open mobile phone handset 302 (for a flip-phone), or another call answer mechanism that may be included in mobile phone handset 302.

Speaker 314 receives an electrical signal containing audio (e.g., voice) information received in a telephone call, and outputs corresponding audio in a well known manner to be heard by the user of mobile phone handset 302. Speaker 314 may be any type of mobile phone compatible speaker, and may be located anywhere in mobile phone handset 302 as desired. For example, speaker 314 may be positioned in mobile phone handset 302 to be located adjacent to a user's ear when the user speaks into microphone 312 of mobile phone handset 302. Microphone 312 receives voice spoken by the user of mobile phone handset 302, and converts the voice information to an electrical audio signal in a well known manner, which is transmitted by mobile phone handset 302 (e.g., by antenna 124 shown in FIG. 1) back to the remote party engaged in the telephone call with the user. Microphone 312 may be any type of mobile phone compatible microphone, and may be located anywhere in mobile phone handset 302 as desired. For example, microphone 312 may be positioned in mobile phone handset 302 to be located adjacent to a user's mouth when the user speaks into mobile phone handset 302.

A user of mobile phone handset 302 interacts with answer switch 306 to initiate answering an incoming telephone call. Microphone 312 receives voice information 324 associated with a telephone call. For example, in an embodiment, voice information 324 is a received greeting, such as “Hello”, from a user of mobile phone handset 302 when first answering the telephone call. Microphone 312 converts voice information 324 into an audio signal 326 that contains voice information 324 in electrical form.

Note that in an embodiment, handset 302 may include speech recognition software/hardware to more accurately detect a received greeting, such as “Hello” for English or comparable greeting for any other language. By detecting such a greeting, handset 302 can better verify that a telephone call has been initiated.

Audio signal compare logic 308 receives audio signal 326 and threshold 310. Furthermore, audio signal compare logic 308 receives a call answered signal 332 from answer switch 306. When a phone call is answered by a user of handset 302 by interacting with answer switch 306, answer switch 306 generates call answered signal 332, which enables audio signal compare logic 308 to perform its functions. Audio signal compare logic 308 is configured to perform a comparison of audio signal 326 with threshold 310, which is a predetermined threshold level stored in mobile phone handset 302. For example, audio signal compare logic 308 compares an attribute of audio signal 326 with threshold 310, such as an amplitude, an energy level, or a power level. Audio signal 326 and threshold 310 may be analog or digital signals, and compare logic 308 may perform the compare in an analog or digital fashion. Audio signal compare logic 308 generates an audio source determination 328. Audio source determination 328 indicates whether audio signal compare logic 308 has determined that audio related to the telephone call should be routed through mobile phone handset 302 or headset 304.

For example, in an embodiment, audio signal compare logic 308 may be configured to compare an energy level of audio signal 326 to threshold 310, which may be a predetermined threshold energy level. Thus, audio signal compare logic 308 may measure an energy level of audio signal 326. Audio signal compare logic 308 compares the energy level of audio signal 326 to threshold 310. If the energy level of audio signal 326 is greater than threshold 310, this indicates that the user of mobile phone handset 302 is likely holding handset 302 relatively close to the user's mouth while voicing the greeting or other voice information that is received by microphone 312, as compared to headset 304. Thus, it is assumed that the user intends to conduct the telephone call while speaking into, and listening to audio from mobile phone handset 302, rather than using headset 304 for this purpose. In this case, audio source determination 328 is configured to indicate that audio related to the telephone call is to be routed through handset 302.

Alternatively, if the energy level of audio signal 326 was less than threshold 310, this indicates that mobile phone handset 302 is likely relatively further from the user's mouth while voicing the greeting or other voice information that is received by microphone 312, as compared to headset 304. Thus, it is assumed that the user intends to conduct the telephone call while speaking into, and listening to audio from headset 304, rather than handset 302. In this case, audio source determination 328 is configured to indicate that audio related to the telephone call is to be routed through headset 304.

If the energy level of audio signal 326 is equal to threshold 310, audio source determination 328 may be configured to indicate that audio related to the telephone call is to be routed through a predetermined one of handset 302 or headset 304 as desired. Such handling of the “equal” condition may be applied to the further embodiments described elsewhere herein.

In an embodiment, first communication interface 316 receives audio source determination 328. First communication interface 316 wirelessly transmits an audio source determination signal 330 that contains audio source determination 328. Audio source determination signal 330 is received by second communication interface 320 of headset 304. When audio source determination 328 indicates that audio related to the telephone call is to be routed through handset 302, audio source determination signal 330 may direct headset 304 to power down, to disable microphone 322 and/or speaker 318, etc. Alternatively, when audio source determination 328 indicates that audio related to the telephone call is to be routed through handset 302, audio source determination signal 330 is not generated, nor transmitted to headset 304, and the call is simply routed through handset 302 without notifying headset 304.

When audio source determination 328 indicates that audio related to the telephone call is to be routed through headset 304, audio source determination signal 330 may direct headset 304 to power up, to enable microphone 322 and/or speaker 318, etc. Subsequent audio related to the telephone call is routed to and from headset 304 via second communication interface 320 by first communication interface 316. In such an embodiment, the user of headset 304 uses speaker 318 to hear audio related to the telephone call, and uses microphone 322 to provide voice for the telephone call.

In an embodiment, headset 304 may be powered up and microphone 322 and speaker 318 may be enabled before audio source determination 328 is generated. In this embodiment, received telephone audio is briefly routed to both speaker 318 and speaker 314 simultaneously until audio source determination 328 is generated. Also in this embodiment, audio signals from microphones 322 and 324 are combined and transmitted over the cellular network to the remote caller. This embodiment thus ensures that audio information is not lost while the audio source determination is made. Note that this technique for ensuring that audio information is not lost while making the audio source determination may be applied to any embodiment described herein, including embodiments described below with respect to FIGS. 4, 5, 7, and 8.

In embodiments, first and second communication interfaces 316 and 320 may be configured to communicate with each other in a wireless fashion according to any suitable communication protocol. For example, first and second communication interfaces 316 and 320 may each include one or more radio frequency (RF) receivers, transmitters, and/or transceivers, as desired. Alternatively, first and second communications interfaces 316 and 320 may communicate with each other in a near field communication manner (e.g., using magnetic coupling), or in other manner, as would be known to persons skilled in the relevant art(s). Furthermore, in an embodiment, first and second communications interfaces 316 and 320 may communicate with each other according to a local area network (LAN) or personal area network (PAN) communication protocol, such as BLUETOOTH or other protocol, as would be known to persons skilled in the relevant art(s).

FIG. 4 shows a block diagram of a telephone call routing system 400, similar to system 300 shown in FIG. 3, according to an example embodiment of the present invention. As shown in FIG. 4, system 400 includes a mobile phone handset 402 and a headset 404, which are respectively similar to mobile phone handset 302 and headset 304 shown in FIG. 3, with some differences provided in the following description.

In the embodiment of FIG. 4, a user of mobile phone handset 402 interacts with an answer switch 406 to initiate answering an incoming telephone call. Answer switch 406 generates a call answered signal 410, which is received by first communication interface 316. First communication interface 316 transmits a first communication signal 412, which includes call answered signal 410. First communication signal 412 is received by second communication interface 320 of headset 404.

Microphone 322 of headset 404 receives voice information 424 associated with the telephone call. For example, in an embodiment, voice information 424 is a received greeting, such as “Hello”, from a user of headset 404 when first answering the telephone call. Microphone 322 converts voice information 424 into an audio signal 426 that contains voice information 424 in electrical form.

In an embodiment, in response to receiving call answered signal 410 at headset 404 (in first communication signal 412), second communication interface 320 transmits a second communication signal 414 that contains audio signal 426 in its entirety, or one or more attributes of audio signal 426 (e.g., in digital form). Alternatively, in another embodiment, call answered signal 410 is not generated. In such an embodiment, second communication interface 320 may transmit audio signal 426 to first communication interface 316 in second communication signal 414 upon receipt of voice information 424 by microphone 322, without needing to first receive call answered signal 410.

First communication interface 316 receives second communication signal 414, and generates an audio signal 418. Audio signal compare logic 408 receives audio signal 418 from first communication interface 316 and receives threshold 310. Audio signal 418 is representative of audio signal 426 received from headset 404. Audio signal compare logic 408 also receives call received signal 332 from answer switch 406. Audio signal compare logic 408 is enabled by call received signal 332 to perform a comparison of audio signal 418 with threshold 310, which is a predetermined threshold level stored in mobile phone handset 302. For example, audio signal compare logic 308 compares an attribute of audio signal 418 with threshold 310, such as an amplitude, an energy level, or a power level of audio signal 418 (in digital or analog form), which is representative of a corresponding amplitude, energy level, or power level of audio signal 426 generated by microphone 322 in headset 404. Audio signal compare logic 408 generates an audio source determination 428. Audio source determination 428 indicates whether audio signal compare logic 408 has determined that audio related to the telephone call should be routed through mobile phone handset 402 or headset 404.

For example, in an embodiment, audio signal compare logic 408 may be configured to compare an energy level of audio signal 426 to threshold 310, which may be a predetermined threshold energy level. Thus, in an embodiment, audio signal compare logic 408 may measure an energy level of audio signal 426. Alternatively, audio signal 418 may provide the energy level (or other attribute) of audio signal 426 in digital or other form. Audio signal compare logic 408 compares the determined energy level of audio signal 426 to threshold 310. If the energy level of audio signal 426 is less than threshold 310, this indicates that the user of mobile phone handset 402 is likely holding handset 402 relatively closer to the user's mouth while voicing the greeting or other voice information that is received by microphone 322, as compared to headset 404. Thus, it is assumed that the user intends to conduct the telephone call while speaking into, and listening to audio from mobile phone handset 402, rather than headset 404. In this case, audio source determination 428 is configured to indicate that audio related to the telephone call is to be routed through handset 402.

Alternatively, if the energy level of audio signal 426 was greater than threshold 310, this indicates that headset 404 is likely relatively closer to the user's mouth while voicing the greeting or other voice information that is received by microphone 322, as compared to mobile phone handset 402. Thus, it is assumed that the user intends to conduct the telephone call while speaking into, and listening to audio from headset 404, rather than handset 402. In this case, audio source determination 428 is configured to indicate that audio related to the telephone call is to be routed through headset 404.

In an embodiment, first communication interface 316 receives audio source determination 428. First communication interface 316 wirelessly transmits an audio source determination signal 416, which is received by second communication interface 320 of headset 404. When audio source determination 428 indicates that audio related to the telephone call is to be routed through handset 402, audio source determination signal 416 may direct headset 404 to power down, to disable microphone 322 and/or speaker 318, etc. Alternatively, in another embodiment, when audio source determination 428 indicates that audio related to the telephone call is to be routed through handset 402, audio source determination signal 416 is not generated, nor transmitted to headset 404, the call is simply routed through handset 402 without notifying headset 404.

When audio source determination 428 indicates that audio related to the telephone call is to be routed through headset 404, audio source determination signal 416 may direct headset 404 to power up, to enable microphone 322 and/or speaker 318, etc. Subsequent audio related to the telephone call is routed to and from headset 404 via second communication interface 320 by first communication interface 316. In such an embodiment, the user of headset 404 uses speaker 318 to hear audio, and uses microphone 322 to provide voice for the telephone call. Furthermore, in an embodiment, speaker 314 and microphone 312 of handset 402 may be disabled, if desired.

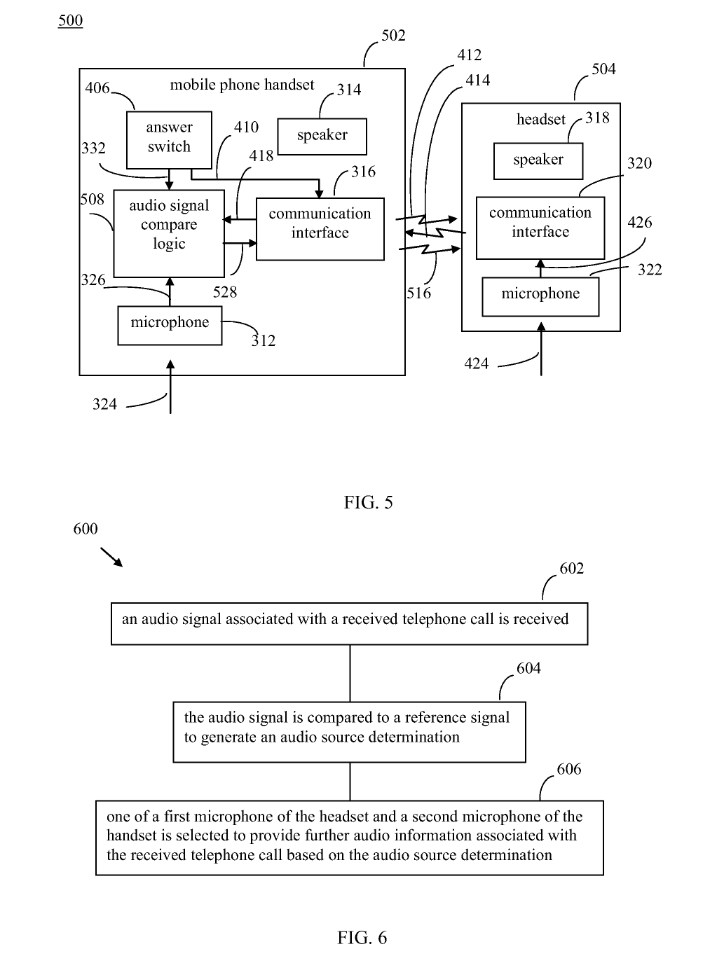

FIG. 5 shows a block diagram of a telephone call routing system 500, similar to system 300 shown in FIG. 3 and system 400 in FIG. 4, according to an example embodiment of the present invention. As shown in FIG. 5, system 500 includes a mobile phone handset 502 and a headset 504, which are respectively similar to mobile phone handsets 302 and 402 and headsets 304 and 404, with some differences provided in the following description.

In the embodiment of FIG. 5, a user of mobile phone handset 502 interacts with answer switch 406 to initiate answering an incoming telephone call. Microphone 312 receives voice information 324 associated with a telephone call. Microphone 312 converts voice information 324 into audio signal 326 that contains voice information 324 in electrical form.

Furthermore, answer switch 406 generates call answered signal 410, which is received by first communication interface 316. First communication interface 316 transmits first communication signal 412, which includes call answered signal 410. First communication signal 412 is received by second communication interface 320 of headset 504.

Microphone 322 of headset 504 receives voice information 424 associated with the telephone call. For example, voice information 424 may be a voice greeting received by handset 502 as voice information 324. Microphone 322 converts voice information 424 into audio signal 426 that contains voice information 424 in electrical form. Note that because the user likely directed the voice greeting into one or the other of microphones 312 and 322, the corresponding one of voice information 324 and 424 will be received at a higher energy/amplitude/power, while the other of microphones 312 and 322 will receive the corresponding one of voice information 324 and 424 at a lower energy/amplitude/power because it is received at a greater distance, etc.

In an embodiment, to response to receiving call answered signal 410 at headset 404, second communication interface 320 transmits audio signal 426 (or one or more attributes thereof) to first communication interface 316 in second communication signal 414. Alternatively, as described above in another embodiment, headset audio request signal 410 does not need to be generated.

Audio signal compare logic 508 receives audio signal 326 from microphone 312 and audio signal 418 from first communication interface 316. Audio signal 418 is representative of audio signal 426 received from headset 504. Audio signal compare logic 508 also receives call answered signal 332 from answer switch 406. Audio signal compare logic 508 is configured to perform a comparison of audio signal 326 of handset 502 with audio signal 418 of headset 504. For example, audio signal compare logic 508 compares a similar attribute of audio signal 326 with the same attribute of audio signal 426, such as an amplitude, an energy level, or a power level. Audio signal compare logic 508 generates an audio source determination 528. Audio source determination 528 indicates whether audio signal compare logic 508 has determined that audio related to the telephone call should be routed through mobile phone handset 502 or headset 504.

For example, in an embodiment, audio signal compare logic 508 may be configured to compare an energy level of audio signal 326 to an energy level of audio signal 426. Audio signal compare logic 508 may include a signal energy determining module to determine the energy levels of audio signals 326 and 426. Alternatively, audio signal 418 may provide the energy level (or other attribute) of audio signal 426 in digital or other form. Audio signal compare logic 508 compares the energy level of audio signal 326 to the energy level of audio signal 426. If the energy level of audio signal 326 is less than the energy level of audio signal 426, this indicates that headset 504 was relatively closer to the user's mouth than was handset 502 while voicing the greeting or other voice information that is received by microphones 312 and 322. Thus, it is assumed that the user intends to conduct the telephone call while speaking into, and listening to audio from headset 504 rather than handset 502. In this case, audio source determination 528 is configured to indicate that audio related to the telephone call is to be routed through headset 502.

Alternatively, if the energy level of audio signal 326 was greater than the energy level of audio signal 426, this indicates that handset 502 was likely closer to the user's mouth than headset 504 while voicing the greeting or other voice information that was received by microphones 312 and 322. Thus, it is assumed that the user intends to conduct the telephone call while speaking into, and listening to audio from handset 502, rather than headset 504. In this case, audio source determination 528 is configured to indicate that audio related to the telephone call is to be routed through handset 502.

In an embodiment, first communication interface 316 receives audio source determination 528 from audio signal compare logic 508. First communication interface 316 wirelessly transmits an audio source determination signal 516 that contains audio source determination 528. Audio source determination signal 516 is received by second communication interface 320 of headset 504. When audio source determination 528 indicates that audio related to the telephone call is to be routed through handset 502, audio source determination signal 516 may direct headset 504 to power down, to disable microphone 322 and/or speaker 318, etc. Alternatively, in another embodiment, when audio source determination 528 indicates that audio related to the telephone call is to be routed through handset 502, audio source determination signal 516 is not generated, nor transmitted to headset 504, the call is simply routed through handset 502 without notifying headset 504.

When audio source determination 528 indicates that audio related to the telephone call is to be routed through headset 504, audio source determination signal 516 may direct headset 504 be enabled for routing (through mobile phone handset 502 as described above) of subsequent audio related to the telephone call. In such an embodiment, the user of headset 504 uses speaker 318 to hear audio, and uses microphone 322 to provide voice for the telephone call. Furthermore, in an embodiment, speaker 314 and microphone 312 of handset 502 may be disabled in this situation, if desired.

In the embodiments of FIGS. 2-5, the audio routing determination is performed in a mobile phone handset. In another embodiment, the audio routing determination is performed in a wireless headset. For example, FIG. 6 shows a flowchart 600 providing example steps in a wireless headset for routing audio related to a telephone call, according to example embodiments of the present invention. Other structural and operational embodiments will be apparent to persons skilled in the relevant art(s) based on the following discussion.

Flowchart 600 begins with step 602. In step 602, an audio signal associated with a received telephone call is received. For example, in FIG. 1, after user 102 initiates answering telephone call 114 on mobile phone handset 104 (e.g., by pressing answer button 118), user 102 typically voices a greeting, such as “Hello” into microphone 122 of mobile phone handset 104 or microphone 112 of wireless headset 112. User 102 typically directs his/her voice into the one of mobile phone handset 104 or wireless headset 112 that user 102 intends to use for conducting telephone call 114, although the voice may be heard more faintly by the other of mobile phone handset 104 or wireless headset 112 (if on). Thus, this voice information is received by one or both microphones, and is converted into an electrical audio signal by microphone 122 of mobile phone handset 104 and/or by microphone 112 of wireless headset 112.

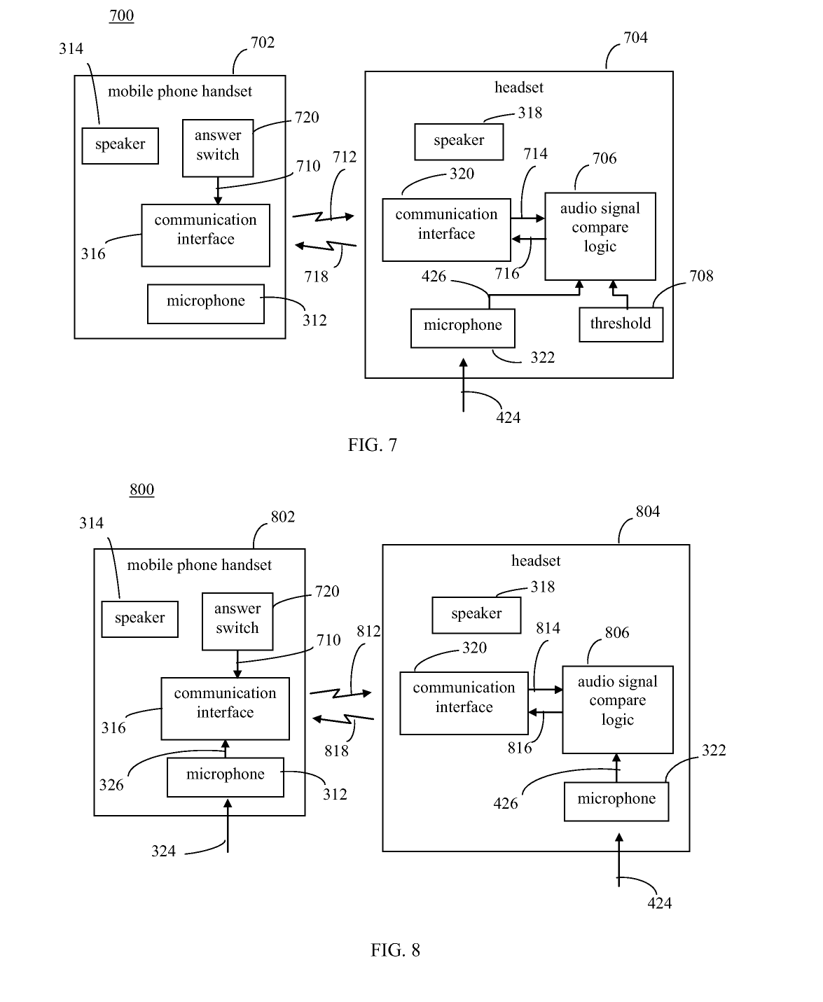

In step 604, the audio signal is compared to a reference signal to generate an audio source determination. In the embodiment of flowchart 600, the audio signal is compared to a reference signal in the wireless headset to determine into which of the handset or headset the voice information was directed by the user. For instance, in an embodiment, the reference signal is a predetermined threshold value, and the audio signal may be generated from voice information received at the handset or headset. In another embodiment, the reference signal may be a second audio signal. For example, the first audio signal may be generated from voice information received at the wireless headset, and the second audio signal may be generated from the voice information received at the mobile phone handset. In any event, the compare of the audio signal to the reference signal is performed in the wireless headset to generate a determination of whether the user is directing voice information into the microphone of the headset or a microphone of the handset. Example embodiments for performing step 604 using compare logic are described in detail further below with regard to FIGS. 7 and 8.

In step 606, one of a first microphone of the headset and a second microphone of the handset is selected to provide further audio information associated with the received telephone call based on the audio source determination. If it is determined from step 604 that the voice information was directed by the user into the wireless headset, audio related to the telephone call is routed through the wireless headset. Conversely, if it is determined from step 604 that the voice information was directed by the user into the mobile phone handset, audio related to the telephone call is routed through the mobile phone handset.

Embodiments for performing flowchart 600 may be implemented in a wireless headset in a variety of ways. For example, FIGS. 7 and 8 show block diagrams of systems for determining the routing for telephone call audio, according to example embodiments of the present invention.

FIG. 7 shows a block diagram of a telephone call routing system 700, according to an example embodiment of the present invention. As shown in FIG. 7, system 700 includes a mobile phone handset 702 and a headset 704. Mobile phone handset 702 includes an answer switch 720, first microphone 312, first speaker 314, and first communication interface 316. Headset 304 includes second speaker 318, second communication interface 320, second microphone 322, an audio signal compare logic 706, and a threshold 708. System 700 is generally similar to system 300 of FIG. 3 described above, except that the audio signal compare is performed in a wireless headset rather than a mobile phone handset.

A user of mobile phone handset 702 interacts with answer switch 720 to initiate answering an incoming telephone call. Answer switch 720 generates a call answered signal 710, which is received by first communication interface 316. First communication interface 316 transmits call answered signal 710 to communication interface 320 of headset 704 in first communication signal 712. Communication interface 320 generates a call answered signal 714, which is received by audio signal compare logic 706. Call answered signal 714 indicates to audio signal compare logic 706 that a telephone call has been answered at handset 702, and that a comparison must be performed to determine whether to route audio related to the telephone call through handset 702 or headset 704.

Microphone 322 receives voice information 424 associated with the telephone call. For example, in an embodiment, voice information 424 is a received greeting, such as “Hello”, from a user of mobile phone handset 702/headset 704 when first answering the telephone call. Microphone 322 converts voice information 424 into audio signal 426 that contains voice information 424 in electrical form.

Note that in an embodiment, headset 704 may include speech recognition software/hardware to more accurately detect a received greeting, such as “Hello” for English or comparable greeting for any other language. By detecting such a greeting, headset 704 can better verify that a telephone call has been initiated.

Audio signal compare logic 706 receives audio signal 426 and threshold 708. Audio signal compare logic 7046 is configured to perform a comparison of audio signal 426 with threshold 708, which is a predetermined threshold level stored in wireless headset 704. For example, audio signal compare logic 706 compares (in analog or digital form) an attribute of audio signal 426 with threshold 708, such as an amplitude, an energy level, or a power level. Audio signal compare logic 706 generates an audio source determination 716. Audio source determination 716 indicates whether audio signal compare logic 706 has determined that audio related to the telephone call should be routed through mobile phone handset 702 or headset 704.

For example, in an embodiment, audio signal compare logic 706 may be configured to compare an energy level of audio signal 426 to threshold 708, which may be a predetermined threshold energy level. Thus, audio signal compare logic 706 may measure an energy level of audio signal 326. Audio signal compare logic 706 compares the determined energy level of audio signal 426 to threshold 708. If the energy level of audio signal 426 is greater than threshold 708, this indicates that the user of wireless headset 704 is likely holding (or wearing) headset 704 relatively close to the user's mouth while voicing the greeting or other voice information that is received by microphone 322, as compared to mobile phone handset 702. Thus, it is assumed that the user intends to conduct the telephone call while speaking into, and listening to audio from wireless headset 704, rather than mobile phone handset 702. In this case, audio source determination 716 is configured to indicate that audio related to the telephone call is to be routed through headset 704.

Alternatively, if the energy level of audio signal 426 was less than threshold 708, this indicates that headset 704 is likely relatively further from the user's mouth while voicing the greeting or other voice information that is received by microphone 322, as opposed to handset 702. Thus, it is assumed that the user intends to conduct the telephone call while speaking into, and listening to audio from handset 702, rather than headset 704. In this case, audio source determination 716 is configured to indicate that audio related to the telephone call is to be routed through handset 702.

In an embodiment, second communication interface 320 receives audio source determination 716. Second communication interface 320 transmits an audio source determination signal 718 that includes audio source determination 716. Audio source determination signal 718 is received by first communication interface 316 of handset 702. When audio source determination 716 indicates that audio related to the telephone call is to be routed through headset 704, audio source determination signal 718 may direct handset 702 to disable microphone 312 and/or speaker 314, etc., if desired in a particular embodiment. Furthermore, audio source determination signal 718 directs handset 702 to route subsequent audio related to the telephone call to and from headset 704.

When audio source determination 716 indicates that audio related to the telephone call is to be routed through handset 702, audio source determination 716 may direct headset 704 to power down, to disable microphone 322 and/or speaker 318, etc., if desired in a particular embodiment. Furthermore, subsequent audio related to the telephone call is not routed to and from headset 704.

FIG. 8 shows a block diagram of a telephone call routing system 800, according to another example embodiment of the present invention. As shown in FIG. 8, system 800 includes a mobile phone handset 802 and a headset 804 which are respectively similar to mobile phone handset 702 and headset 704 of FIG. 7, with some differences provided in the following description. System 800 also has some similarity to system 500 of FIG. 5 described above, except that the audio signal compare is performed in a wireless headset rather than a mobile phone handset.

A user of mobile phone handset 802 interacts with answer switch 720 to initiate answering an incoming telephone call. Answer switch 720 generates call answered signal 710.

Also in handset 802, microphone 312 receives voice information 324 associated with a telephone call. Microphone 312 converts voice information 324 into an audio signal 326 that contains voice information 324 in electrical form.

First communication interface 316 receives call answered signal 710 from answer switch 720 and receives audio signal 326 from microphone 312. First communication interface 316 transmits information of call answered signal 710 and of audio signal 326 to communication interface 320 of headset 804 in a first communication signal 812. Communication interface 320 receives first communication signal 812, and generates a call answered signal 814, which is received by audio signal compare logic 806. Call answered signal 814 indicates to audio signal compare logic 806 that a telephone call has been answered at handset 802, and that a comparison must be performed to determine whether to route audio related to the telephone call through handset 802 or headset 804. Furthermore, call answered signal 814 provides the information of audio signal 326 to audio signal compare logic 806.

Microphone 322 receives voice information 424 associated with the telephone call. Microphone 322 converts voice information 424 into an audio signal 426 that contains voice information 424 in electrical form. Note that because the user likely directed the voice greeting into one or the other of microphones 312 and 322, the corresponding one of voice information 324 and 424 will be received at a higher energy/amplitude/power, while the other of the microphones 312 and 322 will receive the corresponding one of voice information 324 and 424 at a lower energy/amplitude/power because it is received at a greater distance, etc.

Audio signal compare logic 806 receives audio signal 426 generated by microphone 322. Audio signal compare logic 806 is configured to perform a comparison of audio signal 426 (generated by microphone 322 of headset 804) with the audio signal component of call answered signal 814 (i.e., audio signal 326 generated by microphone 312 of handset 802). For example, audio signal compare logic 806 compares a similar attribute of audio signal 426 with the same attribute of audio signal 326, such as an amplitude, an energy level, or a power level. Audio signal compare logic 806 generates an audio source determination 816. Audio source determination 816 indicates whether audio signal compare logic 806 has determined that audio related to the telephone call should be routed through mobile phone handset 802 or headset 804.

For example, if the attribute of audio signal 426 is greater than the same attribute of audio signal 326, this may indicate that the user of wireless headset 804 is likely holding (or wearing) headset 804 relatively close to the user's mouth while voicing the greeting or other voice information that is received by microphone 322, as compared to mobile phone handset 802. Thus, it is assumed that the user intends to conduct the telephone call while speaking into, and listening to audio from wireless headset 804, rather than mobile phone handset 802. In this case, audio source determination 816 is configured to indicate that audio related to the telephone call is to be routed through headset 804.

Alternatively, if the attribute of audio signal 426 was less than the same attribute of audio signal 326, this may indicate that headset 804 is likely relatively further from the user's mouth while voicing the greeting or other voice information that is received by microphone 322, as compared to handset 802. Thus, it is assumed that the user intends to conduct the telephone call while speaking into, and listening to audio from handset 802, rather than headset 804. In this case, audio source determination 816 is configured to indicate that audio related to the telephone call is to be routed through handset 802.

In an embodiment, second communication interface 320 receives audio source determination 816. Second communication interface 320 transmits an audio source determination signal 818, which is received by first communication interface 316 of handset 802. When audio source determination 816 indicates that audio related to the telephone call is to be routed through headset 804, audio source determination signal 818 may direct handset 802 to disable microphone 312 and/or speaker 314, etc., if desired in a particular embodiment. Furthermore, audio source determination signal 818 directs handset 802 to route subsequent audio related to the telephone call to and from headset 804.

When audio source determination 816 indicates that audio related to the telephone call is to be routed through handset 802, audio source determination 816 may direct headset 804 to power down, to disable microphone 322 and/or speaker 318, etc., if desired in a particular embodiment. Furthermore, subsequent audio related to the telephone call is not routed to and from headset 804.

Note that in an embodiment, a comparison with a predetermined threshold may be performed in a headset of an audio signal generated in a mobile phone handset. For reasons of brevity, such an embodiment is not described in detail, but would be apparent to persons skilled in the relevant art(s) from the teachings herein.

### Example Mobile Phone and Headset Embodiments

Embodiments of the present invention can be implemented in a variety of devices, and can be implemented in hardware, software, firmware, and any combination of the same. Embodiments can be implemented in digital form (e.g., digital logic, processors, including DSPs, etc.) and/or in analog form (e.g., using analog comparators, amplifiers, etc.). Example mobile phone devices in which embodiments can be implemented include cell phones, PDAs (personal digital assistants) and other mobile computers, BLACKBERRY devices, handheld music players, etc.

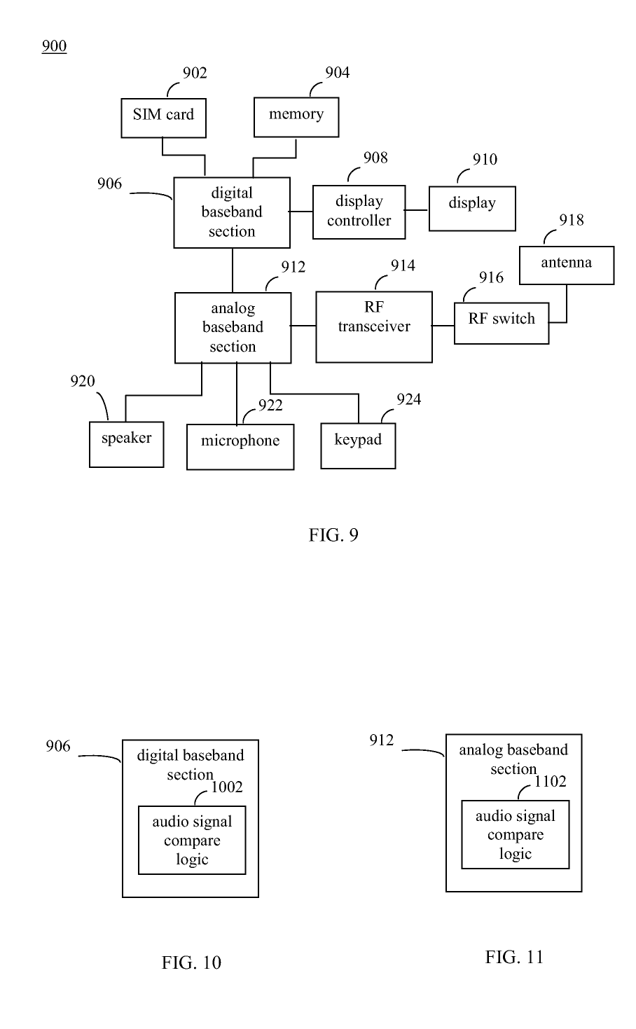

For instance, FIG. 9 shows a block diagram of an example cell phone 900 in which an embodiment of the present invention may be implemented. As shown in FIG. 9, cell phone 900 includes a SIM card 902, a memory 904, a digital baseband section 906, a display controller 908, a display 910, an analog baseband section 912, an RF transceiver 914, an RF switch 916, an antenna 918, a speaker 920, a microphone 922, and a keypad 924. SIM card 902 and memory 904 each are coupled to digital baseband section 906. An output of digital baseband section 906 is coupled to display controller 908. An output of display controller 908 is coupled to display 910. Digital baseband section 906 is coupled to analog baseband section 912. Analog baseband section 912 is coupled to RF transceiver 914. RF transceiver 914 is coupled to RF switch 916. RF switch 916 is coupled to antenna 918. Speaker 920, microphone 922, and keypad 924 are each coupled to analog baseband section 912. Operation of these elements of cell phone 900 is well known to persons skilled in the relevant art(s), and thus is not described in detail herein for purposes of brevity.

Elements of the mobile phone handsets illustrated in FIGS. 3-5, 7, and 8 correspond to similarly named elements of cell phone 900. Furthermore, as shown in FIG. 10, audio signal compare logic 1002, which may be one of audio signal compare logics 308, 408, and 508 shown in FIGS. 3-5, may be implemented in digital baseband section 906 of FIG. 9. Thus, audio signal compare logics 308, 408, and 508 may be implemented in digital form. Alternatively, as shown in FIG. 11, audio signal compare logic 1102, which may be one of audio signal compare logics 308, 408, and 508 shown in FIGS. 3-5, may be implemented in analog baseband section 912 of FIG. 9. RF transceiver 914 of cell phone 900 is used for telephone calls to communicate with a remote entity. Communication interface 316 of mobile phone handsets 302, 402, 502, 702, and 802 shown in FIGS. 3-5, 7, and 8 may include RF transceiver 914 shown in FIG. 9 for communications with a wireless headset, or may include an alternative RF transceiver dedicated for communication with the wireless headset.

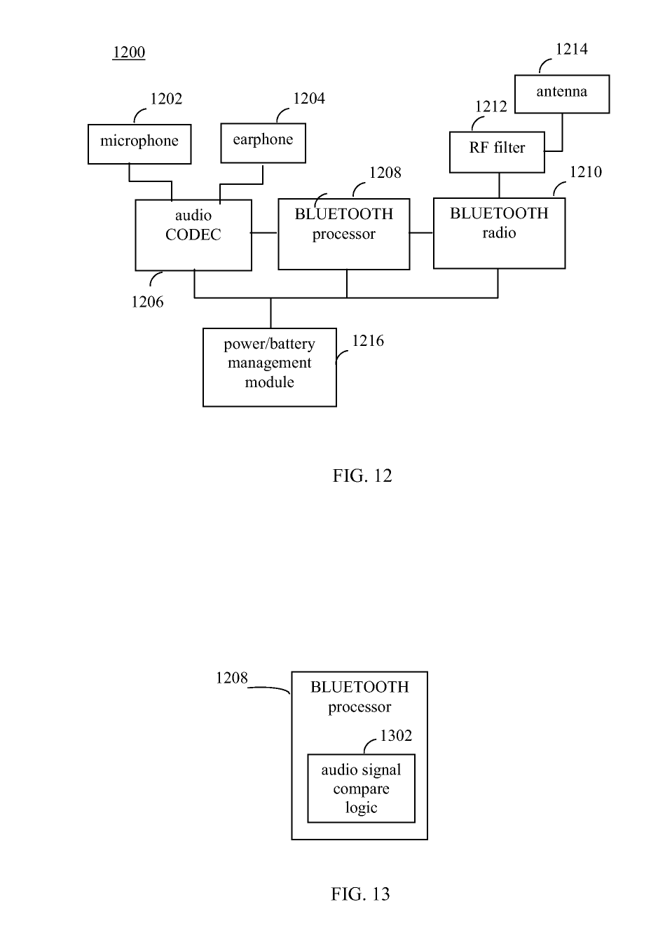

FIG. 12 shows a block diagram of an example BLUETOOTH headset 1200 in which an embodiment of the present invention may be implemented. As shown in FIG. 12, headset 1200 includes a microphone 1202, an earphone 1204, an audio CODEC (coder-decoder) 1206, a BLUETOOTH processor 1208, a BLUETOOTH radio 1210, an RF filter 1212, an antenna 1214, and a power/battery management module 1216. Microphone 1202 and earphone 1204 are each coupled to audio CODEC 1206. Audio CODEC 1206 is coupled to BLUETOOTH processor 1208. BLUETOOTH processor 1208 is coupled to BLUETOOTH radio 1210. BLUETOOTH radio 1210 is coupled to RF filter 1212. RF filter 1212 is coupled to antenna 1214. Power/battery management module 1216 provides power to audio CODEC 1206, BLUETOOTH processor 1208, and BLUETOOTH radio 1210. Operation of these elements of BLUETOOTH headset 1200 is well known to persons skilled in the relevant art(s), and thus is not described in detail herein for purposes of brevity.

Elements of the wireless headsets illustrated in FIGS. 3-5, 7, and 8 correspond to similarly named elements of BLUETOOTH headset 1200. Furthermore, as shown in FIG. 13, audio signal compare logic 1302, which may be one of audio signal compare logics 706 and 806 shown in FIGS. 7 and 8, may be implemented in BLUETOOTH processor 1208 of FIG. 12. Alternatively, audio signal compare logic 1302 may be implemented in audio CODEC 1206. Audio signal compare logics 706 and 806 may be implemented in analog or digital form. Communication interface 320 of headsets 304, 404, 504, 704, and 804 shown in FIGS. 3-5, 7, and 8 may include BLUETOOTH radio 1210 shown in FIG. 12.

### Example Software Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system and to storing software in a computer system or other device. The invention, in an embodiment, is directed to such computer program products.

In an embodiment where aspects of the present invention are implemented using software/firmware, the software/firmware may be stored in a computer program product and loaded into a computer system or other device using a removable storage drive, hard drive, or communications interface. The computer system or other device may execute the software/firmware from storage such as a hard drive or memory device (e.g., a ROM device such as an electrically erasable ROM, electrically programmable ROM, a RAM device such as a static RAM, dynamic RAM, etc.). This control logic software/firmware, when executed by a processor, causes the processor to perform the functions of the invention as described herein.

According to an example embodiment, a device, such as a mobile phone (e.g., cell phone, PDA, BLACKBERRY device, handheld music player, etc.) or headset, may execute computer-readable instructions to enact routing of a phone call through a mobile phone or headset, as further described elsewhere herein, and as recited in the claims appended hereto.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A mobile phone handset, comprising:
a first microphone;
a communication interface configured to wirelessly communicate with a headset; and
a compare logic configured to compare a received audio signal to a reference signal to generate an audio source determination;
wherein one of the first microphone and a second microphone located in the headset is selected to provide further received audio information associated with a received telephone call based on the audio source determination.

2. The mobile phone handset of claim 1, wherein the mobile phone handset is a cell phone.

3. The mobile phone handset of claim 1, wherein the communication interface is configured to wirelessly communicate with the headset according to a Bluetooth communication protocol.

4. The mobile phone handset of claim 1, wherein the audio signal includes voice information associated with the received telephone call received by the first microphone and the reference signal is a predetermined threshold level.

5. The mobile phone handset of claim 1, wherein a second audio signal is received by the mobile phone handset through the communication interface;
wherein the second audio signal includes voice information associated with the received telephone call that is received by the second microphone; and
wherein the audio signal includes voice information associated with the received telephone call that is received by the first microphone and the reference signal is the second audio signal.

6. The mobile phone handset of claim 1, wherein the audio signal is received by the mobile phone handset through the communication interface; and
wherein the audio signal includes voice information associated with the received telephone call received by the second microphone and the reference signal is a predetermined threshold level.

7. The mobile phone handset of claim 1, further comprising:
an answer switch configured to be interacted with by a user to answer a telephone call received on the mobile phone, wherein the answer switch is configured to enable the compare logic to perform the compare.

8. The mobile phone handset of claim 1, further comprising:
a baseband processor module that includes the compare logic.

9. A headset, comprising:
a first microphone;
a communication interface configured to wirelessly communicate with a mobile phone handset; and
a compare logic configured to compare a received audio signal to a reference signal to generate an audio source determination;
wherein one of the first microphone and a second microphone located in the mobile phone handset is selected to provide further received audio information associated with a received telephone call based on the audio source determination.

10. The headset of claim 9, wherein the communication interface is configured to communicate with the mobile phone handset according to a Bluetooth communication protocol.

11. The headset of claim 9, wherein the audio signal includes voice information associated with the received telephone call received by the first microphone and the reference signal is a predetermined threshold level.

12. The headset of claim 9, wherein a second audio signal is received by the headset through the communication interface;
wherein the second audio signal includes voice information associated with the received telephone call that is received by the second microphone; and
wherein the audio signal includes voice information associated with the received telephone call that is received by the first microphone and the reference signal is the second audio signal.

13. The headset of claim 9, wherein the audio signal is received by the headset through the communication interface; and
wherein the audio signal includes voice information associated with the received telephone call received by the second microphone and the reference signal is a predetermined threshold level.

14. The headset of claim 9, wherein the compare logic is configured to be enabled by a call answer signal received from the mobile phone.

15. The headset of claim 9, further comprising:
a baseband processor module that includes the compare logic.

16. A method in a mobile phone handset for routing audio related to a telephone call, the mobile phone handset including a first microphone and being configured to wirelessly communicate with a headset, comprising:
receiving an audio signal;
comparing the audio signal to a reference signal to generate an audio source determination;
selecting one of the first microphone and a second microphone located in the headset to provide further audio information associated with a received telephone call based on the audio source determination.

17. The method of claim 16, wherein the reference signal is a predetermined threshold level, wherein said receiving comprises:
receiving voice information associated with the received telephone call at the first microphone; and
generating the audio signal from the received voice information;
wherein said comparing comprises:
comparing the audio signal to the predetermined threshold level to generate the audio source determination.

18. The method of claim 16, wherein the reference signal is a second audio signal, wherein said receiving comprises:
receiving voice information associated with the received telephone call at the first microphone; and
generating the first audio signal from the received voice information;
wherein said comparing comprises:
receiving the second audio signal from the headset, wherein the second audio signal includes voice information associated with the received telephone call received by the second microphone; and
comparing the first audio signal to the second audio signal to generate the audio source determination.

19. The method of claim 16, wherein the reference signal is a predetermined threshold level, wherein said receiving comprises:
receiving the audio signal from the headset, wherein the audio signal includes voice information associated with the received telephone call received by the second microphone;
wherein said comparing comprises:
comparing the audio signal to the predetermined threshold level to generate the audio source determination.

20. The method of claim 16, further comprising:
receiving an indication of an interaction by a user with an answer switch of the mobile phone to answer the received telephone call on the mobile phone; and
enabling the compare logic to perform the compare based on the received indication.

21. The method of claim 16, further comprising:
disabling a one of the first microphone and the second microphone that was not selected to provide further received audio information associated with the received telephone call.

22. The method of claim 16, wherein said comparing comprises:
comparing an energy of the audio signal to the reference signal to generate the audio source determination.

23. The method of claim 16, wherein said comparing comprises:
comparing an amplitude of the audio signal to the reference signal to generate the audio source determination.

24. A method in a headset for routing audio related to a telephone call, the headset including a first microphone and being configured to wirelessly communicate with a mobile phone handset, comprising:
receiving an audio signal;
comparing the audio signal to a reference signal to generate an audio source determination;
selecting one of the first microphone and a second microphone located in the mobile phone handset to provide further audio information associated with a received telephone call based on the audio source determination.

25. The method of claim 24, wherein the reference signal is a predetermined threshold level, wherein said receiving comprises:
receiving voice information associated with the received telephone call at the first microphone; and
generating the audio signal from the received voice information;
wherein said comparing comprises:
comparing the audio signal to the predetermined threshold level to generate the audio source determination.

26. The method of claim 24, wherein the reference signal is a second audio signal, wherein said receiving comprises:
receiving voice information associated with the received telephone call at the first microphone; and
generating the first audio signal from the received voice information;
wherein said comparing comprises:
receiving the second audio signal from the mobile phone handset, wherein the second audio signal includes voice information associated with the received telephone call received by the second microphone; and
comparing the first audio signal to the second audio signal to generate the audio source determination.

27. The method of claim 24, wherein the reference signal is a predetermined threshold level, wherein said receiving comprises:
receiving the audio signal from the mobile phone handset, wherein the audio signal includes voice information associated with the received telephone call received by the second microphone;
wherein said comparing comprises
comparing the audio signal to the predetermined threshold level to generate the audio source determination.

28. The method of claim 24, further comprising:
receiving an indication of an interaction by a user with an answer switch of the mobile phone to answer the received telephone call on the mobile phone; and
enabling the compare logic to perform the compare based on the received indication.

29. The method of claim 24, further comprising:
disabling a one of the first microphone and the second microphone that was not selected to provide further received audio information associated with the received telephone call.
